(19) United States
(12) Patent Application Publication
(10) Pub. No.: US 2026/0288226 A1
(43) Pub. Date: Sep. 24, 2026

(54) DECREASING VOLTAGE TO A PROCESSOR CORE BASED ON THROTTLING AT THE PROCESSOR CORE

(71) Applicant: INTERNATONAL BUSINESS MACHINES CORPORATION, ARMONK, NY (US)

(72) Inventors: Pradeep Bhadravati Parashurama, Bhadravati (IN); Tobias Webel, Schwaebisch-Gmuend (DE); Phillip John Restle, Katonah, NY (US); Alper Buyuktosunoglu, White Plains, NY (US); Ramon Bertran Monfort, New Orleans, LA (US); Aishwarya Rajiv Tadkase, Bangalore (IN); Alejandro Alberto Cook Lobo, Renningen (DE); Sean Michael Carey, Dutchess, NY (US); KARL EVAN SMOCK ANDERSON, Poughkeepsie, NY (US); Michael ROMAIN, Long Island City, NY (US); Kevin P. Low, Poughkeepsie, NY (US); Rahman Abber Tahir, Herrenberg (DE)

(21) Appl. No.: 19/083,695

(22) Filed: Mar. 19, 2025

(51) Int. Cl. G06F 1/3296; G06F 1/3228; G06F 1/3234

(52) U.S. Cl. CPC G06F 1/3296; G06F 1/3228; G06F 1/3243

(57) ABSTRACT

Provided are a computer implemented method, system, and processor for decreasing voltage to a processor core based on throttling at the processor core. A first sensor in a processor core generates a first output value based on an operational margin at the processor core. Execution at the processor core is throttled in response to the first output value satisfying a threshold condition. A second sensor in the processor core, operating at an offset margin from when the first sensor operates, generates a second output value based on the operational margin at the processor core. A determination is made of a voltage change based on the second output value. A voltage supplied to the processing unit is modified by the voltage change.

### BACKGROUND OF THE INVENTION

The present invention relates to a computer implemented method, system, and processor for decreasing voltage to a processor core based on throttling at the processor core.

In distributed computing environments, there can be numerous jobs or queries arriving as workloads to be processed on a processor in the computing environment. A processor core is a processing unit that reads instructions to perform specific actions. Instructions are chained together so that, when run in real-time on the processor, the processor executes the desired workload formed by the instructions. A multicore processor is a computer processor on a single integrated circuit with two or more separate processing units, which are the cores, each of which reads and executes program instructions. The instructions are ordinary instructions (such as add, move data, branch, etc.) but the single processor can run instructions on separate cores at the same time, increasing the overall speed for programs that support multithreading or other parallel computing techniques.

### SUMMARY

Provided are a computer implemented method, system, and processor for decreasing voltage to a processor core based on throttling at the processor core. A first sensor in a processor core generates a first output value based on an operational margin at the processor core. Execution at the processor core is throttled in response to the first output value satisfying a threshold condition. A second sensor in the processor core, operating at an offset margin from when the first sensor operates, generates a second output value based on the operational margin at the processor core. A determination is made of a voltage change based on the second output value. A voltage supplied to the processing unit is modified by the voltage change.

In a further embodiment for adjusting voltage at a processing unit, a low voltage level is set to a voltage level in response to determining to increase voltage due to excessive throttling. A secondary low voltage level greater than the low voltage level is set. A determination is made as to whether a voltage level is at the secondary low voltage level in response to determining to decrease the current voltage level. A determination is made whether a throttling measurement is below a throttling threshold in response to determining that the voltage level is at the secondary low voltage level. The voltage from the current voltage level is decreased in response to determining that the throttling measurement is below the throttling threshold.

In a further embodiment for adjusting voltage at a processing unit, a first voltage control loop running at a first interval determines whether a first interval throttling measurement, based on a number of times execution at a processor core was throttled during the first interval, exceeds a first throttling threshold. A voltage level is increased a number of steps in response to determining that the first interval throttling measurement exceeds a throttling threshold. A second voltage control loop running at a second interval, longer than the first interval, determines whether a second interval throttling measurement, based on a number of times the processor core was throttled during the second interval, exceeds the throttling threshold. A rate at which the voltage level is decreased is changed in response to determining that the second interval throttling measurement exceeds the throttling threshold.

### BRIEF DESCRIPTION OF THE DRAWINGS

FIG. 1 illustrates an embodiment of a processor including a plurality of cores.

FIG. 2 illustrates an embodiment of a core in the processor.

FIG. 3 illustrates an embodiment of timing control loop operations performed for a core by a first sensor.

FIG. 4 illustrates an embodiment of voltage control loop operations performed by a second sensor for the processor.

FIG. 5 illustrates an embodiment of operations to modify the voltage to the processor core.

FIG. 6 illustrates an embodiment of voltage control loop operations.

FIG. 7 illustrates accumulated throttle data.

FIGS. 8A and 8B illustrate an embodiment of operations to modify voltage based on throttling data.

FIG. 9 illustrates an embodiment of voltage control loops operating at different time intervals.

FIG. 10 illustrates a computing environment in which the components of FIGS. 1 and 2 may be implemented.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description herein provides examples of embodiments of the invention, and variations and substitutions may be made in other embodiments. Several examples will now be provided to further clarify various embodiments of the present disclosure:

Example 1: A computer implemented method for adjusting voltage at a processing unit. A first sensor in a processor core generates a first output value based on an operational margin at the processor core. The method further comprises throttling execution at the processor core in response to the first output value satisfying a threshold condition. A second sensor in the processor core, operating at an offset margin from when the first sensor operates, generates a second output value based on the operational margin at the processor core. The method further comprises determining a voltage change based on the second output value. The method further comprises modifying a voltage supplied to the processing unit by the voltage change. Thus, embodiments advantageously allow a first sensor to determine throttling and a second sensor to determine output values to allow for voltage level increases to avoid the first sensor generating output values indicating voltage level drooping that results in throttling processor execution.

Example 2: The limitations of any of Examples 1 and 3-7, where the method further comprises determining a first voltage change based on the first output value. The method further comprises modifying a first voltage supplied to the processing unit by the first voltage change. The voltage change based on the second output value comprises a second voltage change. The voltage modified by the second voltage change comprises a second voltage. Thus, embodiments advantageously allow for multiple determinations of output values by different sensors to result in finer grain determinations to increase voltage to avoid having the first sensor produce output values that trigger throttling processor execution.

Example 3: The limitations of any of Examples 1, 2 and 4-7, where the method further comprises incrementing a first throttle count in response to output values from the first sensor satisfying the threshold condition. The method further comprises incrementing a second throttle count in response to output values from the second sensor satisfying the threshold condition. The method further comprises using the first throttle count to calculate a first performance degradation value. The method further comprises using the first performance degradation value to determine a first voltage change. The voltage change based on the second output value comprises a second voltage change. The using the second output value to determine the second voltage change comprises using the second throttle count to calculate a second performance degradation value and using the second performance degradation value to determine the second voltage change. Thus, embodiments advantageously provide techniques for estimating performance degradation values based on measured instances of throttling as determined by output values from the first and second sensors to provide more fine grained determinations of when to adjust the voltage based on determinations from different sensors.

Example 4: The limitations of any of Examples 1-3 and 5-7, where the method further comprises that the threshold condition is satisfied in response to the output value being less than a threshold output value. The method further comprises incrementing a threshold output value count in response to output values from the first sensor at one value greater than the threshold output value. The method further comprises using the threshold output value count to determine whether to decrease the voltage. Thus, embodiments advantageously consider counts of output values from the first sensor that are one value greater than the threshold output value in order to determine whether decreasing the voltage should be delayed to avoid oscillations in voltage levels by increasing voltage when the current output value is one step away from indicating to throttle execution.

Example 5: The limitations of any of Examples 1-4, 6, and 7, where the method further comprises that the threshold condition is satisfied in response to the output value being less than a threshold output value. The method further comprises incrementing a threshold output value count in response to output values from the second sensor at one value greater the threshold output value. The method further comprises using the second threshold output value count to determine whether to decrease the voltage. Thus, embodiments advantageously consider counts of output values from the second sensor that are one value greater than the threshold output value in order to determine whether decreasing the voltage should be delayed to avoid oscillations in voltage levels by increasing voltage when the current output value is one step away from indicating to throttle execution.

Example 6: The limitations of any of Examples 1-5 and 7, where the method further comprises that the voltage change comprises a first voltage change. The method further comprises generating, at a third sensor in the processor core at an offset margin from both the first sensor and the second sensor, a third output value based on the operation margin at the processor core. The method further comprises determining a second voltage change based on the third output value. The method further comprises modifying voltage supplied to the processing unit by the second voltage change. Thus, embodiments advantageously utilize a third sensor to provide more fine grained determinations of when to adjust the voltage level to avoid having the first sensor to indicate to increase throttling of processor execution.

Example 7: The limitations of any of Examples 1-6, where the method further comprises generating, at the second sensor, output values based on the operational margin at the processor core. The determining the voltage change is based on the output values from the second sensor, including the second output value. The method further comprises throttling execution at the processor core in response to the second output value satisfying the threshold condition. Thus, embodiments advantageously have a second sensor determine output values that may be used to increase the voltage level to avoid the first sensor from generating output values that cause throttling of processor execution.

Example 8: A computer implemented method for adjusting voltage at a processing unit. A low voltage level is set to a first voltage level in response to determining to increase voltage due to excessive throttling. The method further comprises setting a secondary low voltage level greater than the low voltage level. The method further comprises determining whether a second voltage level is at the secondary low voltage level in response to determining to decrease the second voltage level. The method further comprises determining whether a throttling measurement is below a throttling threshold in response to determining that the second voltage level is at the secondary low voltage level. The method further comprises decreasing the second voltage level in response to determining that the throttling measurement is below the throttling threshold. Thus, embodiments advantageously comprise additional determinations before decreasing the voltage level when the voltage level is just above a voltage level that resulted in increasing the voltage. This avoids continual oscillations in voltage levels by considering whether to hold off decreasing the voltage until additional determinations are made indicating that immediate oscillations in voltage levels may not occur.

Example 9: The limitations of any of Examples 8 and 10-14, where the method further comprises that the throttling measurement comprises average throttling since increasing the voltage. Thus, embodiments advantageously consider average throttling in the current period since increasing the voltage to improve determinations whether to decrease the voltage by averaging throttling over the most relevant time period.

Example 10: The limitations of any of Examples 8, 9 and 11-14, where the method further comprises that the average throttling is calculated as an amount of throttling since increasing the first voltage level divided by a number of periods since increasing the first voltage. Thus, embodiments advantageously consider average throttling in the current period since increasing the voltage to improve determinations whether to decrease the voltage by averaging throttling over the most relevant time period.

Example 11: The limitations of any of Examples 8-10 and 12-14, where the method further comprises that the throttling measurement comprises a first throttling measurement. The method further comprises waiting a number of periods in response to determining that the first throttling measurement is above the throttling threshold before decreasing the second voltage level. The method further comprises in response to waiting the number of periods, determining whether a second throttling measurement is below the throttling threshold. The method further comprises decreasing the second voltage level in response to determining that the second throttling measurement is below the throttling threshold. Thus, embodiments advantageously ensure that throttling has been below a throttling threshold consistently for a number of periods. This indicates stability of the voltage level such that decreasing the voltage will unlikely result in excessive throttling causing an increase and oscillation in the voltage level.

Example 12: The limitations of any of Examples 8-11, 13, and 14, where the method further comprises that the number of periods to wait is based on an amount of throttling since increasing the first voltage level. The number of periods to wait increases as the amount of throttling increases since increasing the first voltage level. Thus, embodiments advantageously determine the number of periods to wait before considering to decrease the voltage based on amount of throttling to increase the wait period before reducing the voltage level if throttling has increased since the last voltage increase. This allows further reducing the rate at which the voltage level is decreased during times of high throttling.

Example 13: The limitations of any of Examples 8-12 and 14, where the method further comprises that the number of periods to wait comprises a factor, greater than one, times an amount of throttling since increasing the first voltage level divided by the throttling threshold minus a number of periods since the voltage was increased. Thus, embodiments advantageously determine the number of periods to wait before considering to decrease the voltage based on amount of throttling to increase the wait period before reducing the voltage level if throttling has increased since the last voltage increase. This allows further reducing the rate at which the voltage level is decreased during times of high throttling.

Example 14: The limitations of any of Examples 8-13, where the method further comprises determining whether the low voltage level is set in response to determining to decrease the second voltage level. The method further comprises decreasing the second voltage level from the current voltage level in response to determining that the low voltage level is not set. Thus, embodiments advantageously allow for the voltage level to decrease if a low voltage level resulting in an increase in the voltage level has not occurred because reducing the voltage level will unlikely result in increased throttling.

Example 15: A computer implemented method for adjusting voltage at a processing unit. The method comprises a first voltage control loop running at a first interval to determine whether a first interval throttling measurement, based on a number of times execution at a processor core was throttled during the first interval, exceeds a first throttling threshold. The method further comprises increasing a voltage level a number of steps in response to determining that the first interval throttling measurement exceeds a throttling threshold. The method further comprises a second voltage control loop running at a second interval, longer than the first interval, to determine whether a second interval throttling measurement, based on a number of times the processor core was throttled during the second interval, exceeds the throttling threshold. The method further comprises changing a rate at which the voltage level is decreased in response to determining that the second interval throttling measurement exceeds the throttling threshold. Thus, embodiments advantageously provide additional voltage control loops provide additional adjustments to the voltage level to avoid situations of excessive throttling.

Example 16: The limitations of any of Examples 15, 17, and 18, where the method further comprises that the throttling threshold comprises a first throttling threshold. The changing the rate at which the voltage level is adjusted in response to determining that the second interval throttling measurement exceeds the first throttling threshold comprises performing at least one of: increasing the number of periods required during which throttling is below a second throttling threshold before decreasing the voltage level, wherein the second throttling threshold is less than the first throttling threshold; and decrementing the first throttling threshold. Thus, embodiments advantageously reduce the rate at which the voltage level is decreased if throttling is determined to be at an excessively high level to avoid voltage reductions that will result in oscillations in voltage levels due to excessive throttling.

Example 17: The limitations of any of Examples 15, 16, and 18, where the method further comprises that the throttling threshold comprises a first throttling threshold. The changing the rate at which the voltage level is adjusted in response to determining that the second interval throttling measurement is below the first throttling threshold comprises performing at least one of: decreasing the number of periods required during which throttling is below a second throttling threshold before decreasing the voltage level, wherein the second throttling threshold is less than the first throttling threshold; and incrementing the second throttling threshold. Thus, embodiments advantageously increase the rate at which the voltage level is decreased if throttling is determined to be below a throttling threshold, indicating that reductions in voltage levels will not result in oscillations in voltage levels due to excessive throttling.

Example 18: The limitations of any of Examples 15-17, where the method further comprises a third voltage control loop running at a third interval, longer than the second interval, to determine whether a third interval throttling measurement, based on a number of times the processor core was throttled during the third interval, exceeds the throttling threshold. The method further comprises performing pattern matching detecting to predict high throttling time periods using historical throttling data. The method further comprises scheduling, for the high throttling time periods, to decrease the rate at which the voltage level is decreased to maintain the voltage level at a higher level. Thus, embodiments advantageously provide a third voltage control rate to increase determinations of whether voltage levels should be increased to further avoid the first sensor producing output values indicating voltage droops that would trigger additional throttling.

Example 19 is an apparatus comprising means to perform a method of any of the Examples 1-18.

Example 20 is a machine-readable storage including machine-readable instructions, when executed, to implement a method or realize an apparatus of any of the Examples 1-18.

Example 21: A system comprising one or more processor and one or more computer-readable storage media collectively storing program instructions which, when executed by the processor, are configured to cause the processor to perform a method according to any of Examples 1-18.

Example 22: A computer program product comprising one or more computer readable storage media, and program instructions collectively stored on the one or more computer readable storage media, the program instructions comprising instructions configured to cause one or more processors to perform a method according to any one of Examples 1-18.

Example 23: The limitations of Example 1-7 and 15, wherein embodiments advantageously allow the first voltage control loop of Example 15 to determine a voltage change based on the second output value from the second sensor according to the operations of Examples 1-7.

Example 24: The limitations of Example 1 and 8-14, wherein embodiments advantageously allow considerations to change the voltage in Example 1 based on a low voltage level at which the voltage was increased according to Examples 8-14 to avoid decreasing the voltage level to cause oscillations in voltage level resulting from decreases in the voltage level that would result in excessive throttling.

High transistor counts and dense circuits in a processor results in nanosecond timescale changes in current and a supply voltage droop, i.e., reduction in voltage having significant impacts on performance, when a workload suddenly increases power demand. To preserve timing margin and prevent circuit failure, the input supply voltage must account for the maximum workload induced droop in addition to other guardband components protected by the voltage and timing management at the processor. Droop mitigation techniques to prevent large drops in voltage, also known as droops, that can result in errors, include core throttling and rapid frequency reduction that increase number of cycles needed to execute an instruction.

Described embodiments provide improvements to processor guardband techniques to prevent supply voltage droops using multiple timing protection control loops at the cores in a processor to allow rapid throttling of execution of instructions at the cores upon detecting timing margins or voltage margins reaching thresholds indicating performance degradation. Described embodiments provide a first sensor to throttle execution at the core in response to detecting an output value satisfying a threshold condition, such as a throttling threshold. A second sensor operating at an offset of margin compared to the first sensor, such that for very near critical voltage, the second sensor would have crossed the throttling threshold while the first sensor did not cross the throttling threshold. This allows for increasing the voltage supplied to the processor to reduce voltage drooping before the first sensor detects high throttling.

Further embodiments provide techniques to avoid lowering the voltage to a level that results in excessive throttling causing voltage to increase by controlling voltage decreases during times of low throttling. Described embodiments determine a low voltage level where voltage was increased due to excessive throttling. A secondary low voltage level is set at one or more steps above the low voltage level. To avoid going back to the low voltage level where voltage levels increase, described embodiments decrease the voltage from the secondary low voltage level when a throttling measurement is below a throttling threshold. In this way, described embodiments decrease the voltage at the secondary low voltage level when throttling is not excessive or below a threshold to avoid returning to the low voltage level during a period of high throttling which may trigger a voltage increase.

Further described embodiments utilize multiple voltage control loops. A first voltage control loop is used to determine when to increase the voltage to the core when throttling reaches a threshold level. Additional voltage control loops operate at longer time intervals than the first voltage control loop to determine whether to increase the rate at which the voltage level is increased. In this way, additional voltage control loops provide additional adjustments to the voltage level to avoid situations of excessive throttling.

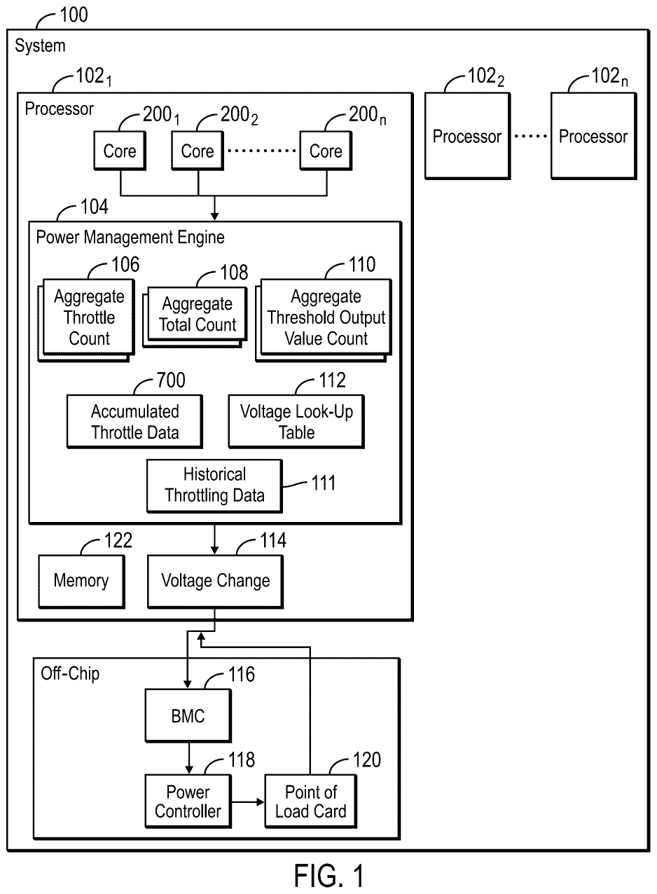

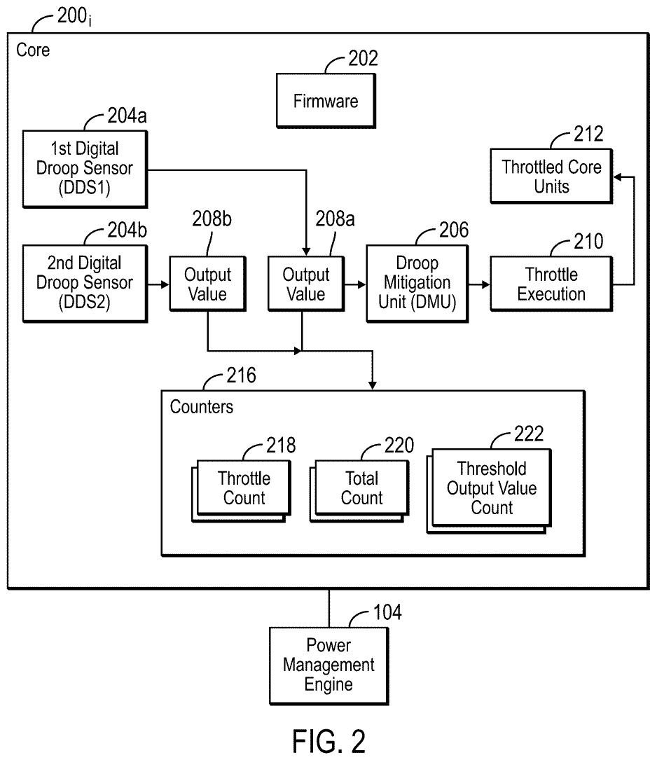

FIG. 1 illustrates an embodiment of a system 100 including a plurality of processors 102₁, 102₂ . . . 102ₙ. Each processor 102ᵢ, as shown with respect to processor 102₁, may include one or more processing cores 200₁, 200₂ . . . 200ₙ. FIG. 2 illustrates an embodiment of one of the cores 200ᵢ. The core 200ᵢ includes firmware 202 to manage core operations. A core 200ᵢ further includes a plurality of digital droop sensors (DDSs) 204a, 204b, also referred to as first and second sensors. In certain embodiments, one DDS 204a is coupled to a droop mitigation unit (DMU) 206 implementing a timing protection control loop implemented in hardware. The second DDS 204b may not be coupled to the DMU 206. The DDSs 204a and 204b comprise analog or digital components to detect an operational margin, such as a timing margin or voltage margin, comprising a difference between the actual timing or voltage from a margin threshold value. The DDSs 204a, 204b may convert the detected operational margin, such as a timing cycle time, to output values 208a, 208b, respectively, comprising one of a fixed number of possible output values. The DDSs 204a, 204b may comprise other types of sensors to measure and sense other types of operation metrics in the core relevant to determining the occurrence of performance degradation and voltage droops.

The DMU 206 may process the output value 208 from the first DDS to determine whether mitigation techniques are needed, such as core execution throttling and rapid frequency reduction to mitigate a droop. Upon the DMU 206 determining to implement mitigation, the DMU may perform throttle execution 210 to throttle or increase a number of cycles to execute an instruction at throttled core units 211, such as an instruction fetch and branch, instruction cache and merge, instruction decode, and instruction sequence. The DMU throttles the core when the first DDS output value falls below a throttle output value. One advantage of throttling over other mitigation methods is that the throttling can persist as long as needed until margin increases above the throttling-threshold value.

The DDSs 204a, 204b may comprise a programmable delay feeding a latch-tapped delay line with a fixed number of possible output values. In certain embodiments, the DDSs 204a, 204b may be programmed at different delays. The DDSs 204a, 204b may be placed close to each other in a core so they operate under the same conditions. The delay may cause the DDSs to output different output values when all other chip conditions are constant, such as voltage, frequency, temperature, and workload. The programmable delays may be set at calibration. The second DDS at a delay from the first DDS may generate the output value at a slightly higher voltage. The first DDS is connected to throttling, or the DMU, while the second DDS may not be connected to the DMU. Firmware can read the second DDS output value to use as a proactive indicator to change voltage even before there is a chance for the first DDS to throttle. This will avoid throttling and performance is improved. In an alternative embodiment, the second DDS may also be connected to the DMU 206 to cause throttling. Although two DDSs are shown, in further embodiments, there may be further DDSs operating at different delays to provide more fine grain measurements of the output value to allow additional voltage control operations to reduce throttling.

The first DDS output values may be interpreted by the DMU 206 within nanoseconds. In certain embodiments, the DDSs are designed using gates and devices common to critical paths in the core. This ensures that the DDSs'sensitivity to voltage, temperature and accelerated End-Of-Life (EOL) stressing corresponds to that of the core's critical paths. For example, if threshold voltages increase slightly towards EOL, both critical paths and DDSs will slow. The voltage control loop will increase voltage slightly at EOL to maintain timing margin and performance.

Both DDSs 204a, 204b may further forward the output values 208a, 208b to counters 216, where there is a set of counters for each DDS, including a throttle count 218, a total count 220, an threshold output value count 222, respectively. If the output values 208a, 208b are less than or equal to a throttle output value at which throttling is to occur, then the throttle counter increments the throttle count 218 for the respective DDS. In this way, the throttle count 218 may track how many cycles are throttled to monitor the performance impact from throttling. The total count 220 is incremented to indicate a total number of output values 208a, 208b for a particular DDS that occur in between operations of the voltage control loop. The threshold output value count 222 indicates a number of times the output values 208a, 208b for the DDSs were an output value immediately above the throttle output value, or the first value at which throttling is not to occur. This is a threshold output value at the margin immediately above the output value at which throttling is triggered. The DDSs 204a, 204b record the counts for use by the voltage control loop to determine whether to increase or decrease a voltage supplied to the processor 102ᵢ including the core 200ᵢ implementing the timing control loop.

The power management engine 104 may read the counts 218, 220, 222, in the different cores at a frequency multiple times the frequency at which the DDS monitors the margin, such as the timing margin. For instance, the DDSs, at offsets from each other, may each separately monitor timing margins every cycle. The power management engine 104 may read the counters every 16 ms, which is magnitudes less than the cycles per second in the processor, which may be in the billions. The power management engine 104 uses the read counts to determine whether to modify the voltage supplied to the processor 102ᵢ.

With respect to FIG. 1, the power management engine (PME) 104 may be located on the processor chip external to the cores. The power management engine 104 aggregates the throttle count 218, total count 220, and threshold output value count 222 from the DDSs in the cores into aggregate counts 106, 108, 110, respectively. There may be separate counts 106, 108, 110 for each DDS. In this way, counts are maintained separately for each of the DDSs. The counts 106, 108, 110, 218, 220, 222 may also be referred to as counters.

The power management engine 104 may use the aggregate throttle count 106 for a DDS to determine a performance degradation value indicating an extent to which throttling was triggered by performance degradations in timing or voltage detected by the particular DDS. The performance degradation value may be inputted into a voltage look-up table 112. The voltage look-up table 112 associates different performance degradation values with different voltage changes. The voltage look-up table outputs a voltage change 114 based on an input performance degradation value. For instance, greater performance degradation values may result in higher voltage increases to improve performance than lower performance degradation values requiring a lessor voltage increase to boost performance. Further, the voltage control loop implemented by the power management engine is asymmetric, increasing voltage more quickly than lowering. If a high rate of throttling is observed in any voltage control loop period, e.g., 16 ms, the voltage is increased a relatively large amount, such as up to 4% in a single request. Voltage decreases may be fixed at a lower increase level, e.g., 0.5% and require low throttling for at least 64 ms before a request is made.

The power management engine 104 may further maintain accumulated throttle data 700 that is used to determine how to adjust the voltage. Historical throttling data 111, be collected over more extended periods of time than the accumulated throttle data, may be used to determine patterns in throttling used to determine schedules for adjusting voltage based on detected throttling patterns over extended periods of time.

The processor may further include a memory 122 to store data used by the cores from an external storage. Further, the cores may each include L1 and L2 caches (not shown) to buffer data from the processor memory 122 for immediate use.

In certain embodiments, the power management engine 104 may change the DDSs delays and change supply voltage.

In alternative embodiments, instead of using a voltage look-up table 112, the power management engine 104 may input a performance degradation value to a function or program to then calculate the voltage change. The function or program may comprise an algorithm, heuristic rules-based system or machine learning model to determine a voltage change from a performance degradation value. In further embodiments, the function used to output the voltage change may receive as input other information and factors that could affect an optimal voltage change determination, including, but not limited to, a temperature at the processor, whether the processor is in a maintenance mode, whether a current voltage is within a limit whether the modified voltage resulting from the calculated voltage change is within a limit when the current voltage is not within the limit; whether power is within a limit; and whether the power of other system components are within a limit.

The power management engine 104 may forward the voltage change 114 with a command to a baseboard management controller (BMC) 116 to control a processor power controller 118 to produce an adjusted voltage to a point of load card (POL) 120 to provide the precise adjusted voltage to the processor or cores within the processor.

In the embodiment of FIG. 1, the voltage control loop to produce voltage change is applied to the processor and cores therein as a whole. In this way, the same adjusted voltage is supplied to all the cores. In an alternative embodiment, there may be a separate voltage control loop for each core to allow independent adjustment of the voltage supplied to each core. In still further embodiments, there may be multiple voltage control loops, including one voltage control loop for a subset of cores.

In the embodiment of FIG. 1, there is a separate timing protection control loop, comprised of the DDS and DMU, for each core, within the core. In alternative embodiments, one timing protection control loop may perform throttling for multiple cores.

The term processing unit may refer to any type of processing unit, including a processor having cores, one or more of the cores on a processor chip, a chiplet, etc.

The components in the processor and core, including 104, 106, 111, 112, 116, 118, 120, 204, 206, 212, 214, 216, 700, may be implemented as hardware or firmware or a combination thereof.

The arrows shown in FIGS. 1 and 2 illustrate a flow and direction of operations as well as connections between components.

The system 100 may comprise various types of computing devices, including desktop computers, servers, laptops, tablets, smartphones, wearable computers, network devices, inference engines, etc.

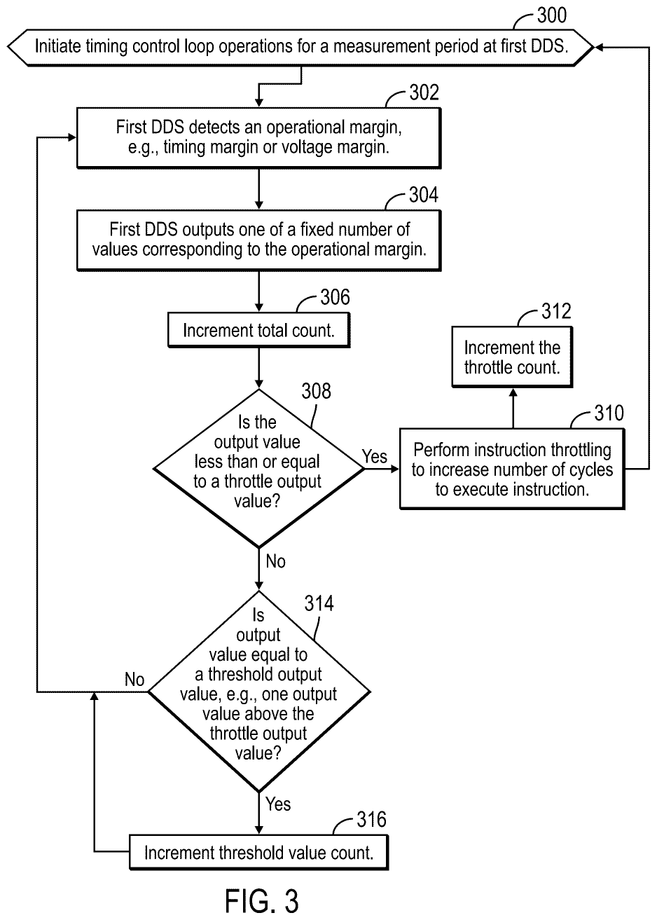

FIG. 3 illustrates an embodiment of operations performed in the timing protection control loop by a first DDS of multiple DDSs, or other types of sensor, and the DMU. In certain embodiments, the sensor and DMU may comprise the DDS 204a and DMU 206 described with respect to FIGS. 1 and 2. Timing protection control loop operations may be performed on every cycle, and there may be billions of cycles per second. Upon initiating (at block 300) timing control loop operations, the first DDS, or other type of sensor, detects or infers (at block 302) an operational margin, such as a timing margin or voltage margin. The first DDS outputs (at block 304) one of a fixed number of possible values corresponding to the operational margin. The total count 220 may be incremented (at block 306) to indicate the number of output values produced. If (at block 308) the output value is less than or equal to a throttle output value, then the DMU may initiate (at block 310) throttle execution to increase the number of cycles to execute an instruction. The throttling is performed as part of a droop mitigation technique, such as core throttling and repad frequency reduction. Upon throttling, the throttle count 218 may be incremented (at block 312), which indicates a number of cycles during which the cores were not submitting instructions. If (at block 314) the output value is equal to a threshold output value, which may comprise an output value one above the throttle output value, then the threshold output value count 222 may be incremented (at block 316). From block 316 or the NO branch of block 314, control proceeds back to block 302 to perform another iteration of timing protection control loop operations to determine whether to further throttle instruction execution to avoid voltage droops.

With the embodiment of operations of FIG. 3, timing protection control loop operations are performed to introduce throttling to preserve a timing margin and prevent circuit failure. Further, as part of determining whether to throttle and mitigate based on the first DDS output, certain counts may be incremented to gather information for the voltage control loop to determine a performance degradation value and other values used to determine whether to change the voltage.

In described embodiments, the operations of FIG. 3 are performed by just one of the DDSs. In further embodiments, multiple of the plurality of DDS may perform the operations of FIG. 3 at different delays.

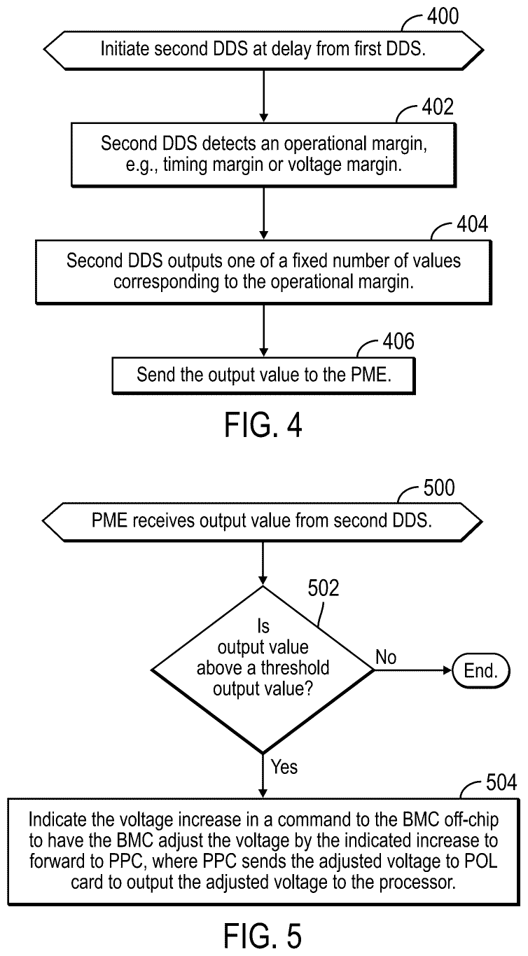

FIG. 4 illustrates an embodiment of operations performed at the second DDS operating at a delay from the first DDS. Upon initiating (at block 400) the second DDS, the second DDS detects (at block 402) an operational margin, e.g., timing margin or voltage margin, at the core. The second DDS outputs (at block 404) one of a fixed number of values corresponding to the operational margin and sends (at block 406) to the PME to update the counts for the second DDS. Alternatively, the output value of the second DDS may be saved and read by the power management engine.

With the embodiment of FIG. 4, the second DDS sends its output values measured from operational margins to the power management engine to determine whether to increase or decrease voltage. In the embodiment of FIG. 4, the second DDS is not coupled to the throttling and DMU unit 206. In an alternative embodiment, the output value of the second DDS may be transmitted to the DMU to also implement throttling.

FIG. 5 illustrates an embodiment of operations performed by the power management engine to update the throttling information from output values from the second DDS. Upon the power management engine receiving (at block 500) an output value from the second DDS, if (at block 502) the output value is above a threshold output value, then the power management engine indicates (at block 504) a voltage increase in a command to the BMC off-chip to have the BMC modify the voltage by the indicated increase and forward to the PPC to send the adjusted voltage to a POL card to output the adjusted voltage to the processor.

With the embodiment of FIGS. 3, 4, and 5, the use of a plurality of DDSs increases the resolution of the throttling operations. For instance, at time N, the first DDS output may be 11 and indicate no-throttling, such as if the throttling threshold is 10. At time N+1, the first DDS output may become 10 and throttling will start. However, to avoid throttling at N+1, at time N+0.5, the second DDS may output a value of 10 because it is tuned to a higher delay than the first DDS. The second DDS output having a value below the throttling threshold may trigger an increase in voltage before the first DDS output value changes to below the throttling value to trigger throttling. Further, if there are three DDSs, the third DDS may operate at delay at time N+0.75 to increase voltage before throttling is initiated by the first DDS.

In further embodiments, the second DDS may be calibrated to produce output values at a higher voltage than the first DDS. In this way, for a same output value, the second DDS will output that output value at a higher voltage than the first DDS.

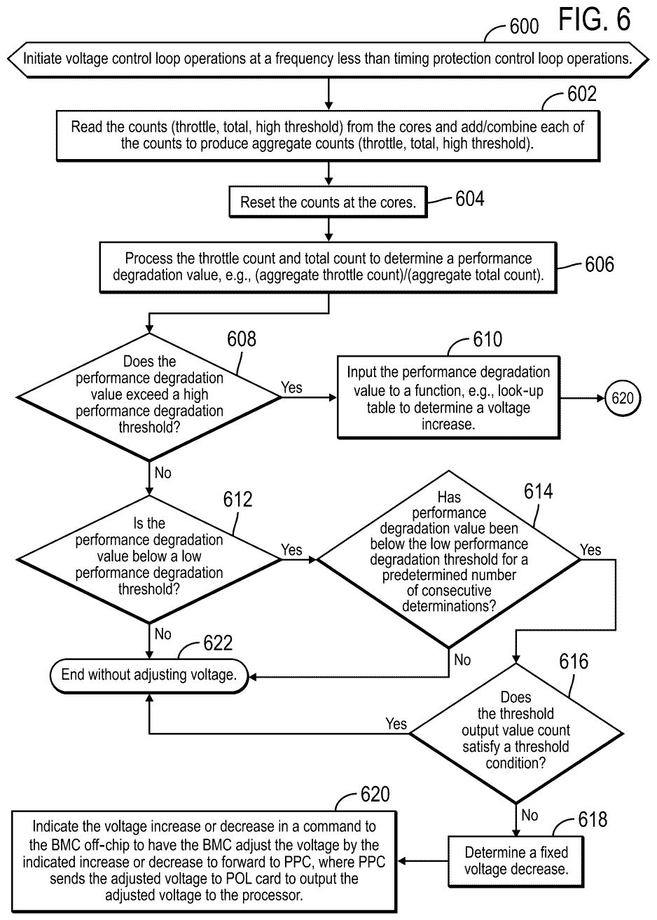

FIG. 6 illustrates an embodiment of voltage control loop operations to periodically determine whether to modify the voltage supplied to the processor and cores therein. Upon initiating (at block 600) a voltage control loop, which occurs after performing numerous timing control loop operations of FIG. 3 at the first DDS or at FIG. 4 at the second DDS, the performance management engine reads (at block 602) the counts (throttle, total, threshold) from the cores for the first and/or second DDS and combines each of the count types read from the cores to produce the aggregate throttle count, the aggregate total count, and the threshold output value count, respectively. The counts in the cores may be reset (at block 604). The performance management engine may process (at block 606) the aggregate throttle count and aggregate total count for a DDS to determine a performance degradation value for a particular DDS, such as by dividing the aggregate throttle count by the aggregate total count. This value provides indication of percentage of cycles during which instructions were not executed or throttled.

If (at block 608) the performance degradation value exceeds a high performance degradation threshold, then, in response, the performance degradation value is inputted (at block 610) to a function, such as a look-up table, to determine a voltage increase. If (at block 608) the performance degradation value does not exceed the high threshold, then if (at block 612) the performance degradation value is below a low performance degradation threshold, which may be less than the high performance degradation threshold, then the voltage may be eligible to decrease. In one embodiment, after determining the performance degradation value is below the low performance degradation threshold, a voltage decrease may be indicated, comprising a fixed value. The voltage decrease may be less than the voltage increases. In further embodiments, to avoid oscillation events where a decrease in voltage results in excessive throttling as part of the timing protection control loop, the operations at blocks 614 and/or 616 may be performed to determine whether to delay a voltage decrease to avoid oscillations back to unacceptable performance degradation requiring throttling and possibly a large voltage increase.

If (at block 614) the performance degradation value has been below the low performance degradation threshold for a predetermined number of consecutive determinations, then control may proceed to block 616 for a further test to determine whether to decrease voltage. When the output value from a particular DDS remains above the throttling value, the throttling counters will not increment and there is not performance loss. There may be additional counts that increment for higher DDS output values. These additional counts can be used to prevent large oscillations in the voltage control loop. In one embodiment, an additional oscillation threshold output value count is used to calculate the percentage of time that the margin is just above the throttling threshold value. If (at block 616) the threshold output value count, e.g., 222, satisfies a threshold condition, then a determination is made (at block 618) of a predetermined fixed voltage decrease. The threshold condition may be triggered if the threshold output value count or percentage of output values in the threshold output value count exceeds a predetermined value or percentage. The threshold condition indicates a low noise workload in which case a small decrease in voltage may result in a large increase in throttling performance loss. In this case no voltage decrease will be requested. In response to block 610 or 618, the performance management engine may indicate (at block 620) the voltage increase or decrease in a command transmitted to the BMC off-chip to have the BMC adjust the voltage by the indicated voltage increase or decrease to forward to the processer power control (PPC). The PPC may then send the adjusted voltage to the POL card to output the adjusted voltage to the processor. From the NO branch of block 612, the NO branch of block 614 or the YES branch of block 616, control may end without adjusting the voltage.

In the embodiment of FIG. 6, both blocks 614 and 616 may be performed to consider delaying a voltage decrease. In alternative embodiments, in response to the YES branch of block 614, control may proceed directly to block 618 without performing the check at block 616. In a further embodiment, from the YES branch of block 612, control may proceed directly to block 616, skipping block 614, and then in response to the NO branch of block 616 to block 618.

The check at block 614 is to ensure that the detected acceptable level of performance degradation is not just transitory and acceptable levels of performance degradation are consecutively detected to indicate the workload is stable and the voltage may be decreased without causing an oscillation back to an unacceptable level of degradation.

The check at block 616 is to determine how many DDS output values are immediately above the throttle output value. For instance, if the threshold output value count indicates that number or percentage of output values immediately above the throttle output value exceed some condition, then there is a likelihood that decreasing the voltage will affect performance to cause the DDS output to decrease one output value back to the throttle output value triggering more throttling and possible large voltage increase. However, if the number output values immediately above the throttle output value do not exceed some condition or are not too high, then voltage may be reduced without triggering a large oscillation in voltage and performance loss. Small oscillations may still occur resulting in acceptably small performance loss and power increases.

With the embodiment of FIG. 6, blocks 614 and/or 616 are performed to limit the voltage decrease to situations where the result of the voltage decrease will not likely oscillate back to excessive performance degradation and throttling.

In one embodiment, the power management engine in FIG. 5, may determine to increase the voltage in response to an output value from the second DDS determined above a threshold output value without performing the operations of FIG. 6. In an alternative embodiment, the power management engine may perform the operations in FIG. 6 based on output values from the second DDS to determine whether to increase or decrease the voltage.

FIG. 7 illustrates an embodiment of the information maintained for the accumulated throttle data 700 used in determining how to decrease the voltage using throttle data accumulated over time. A voltage cliff variable V_{cliff} 702 indicates a low voltage level to which the voltage was lowered by the voltage control loop resulting in increased throttling beyond a throttling threshold. A voltage edge variable V_{edge} 704 is a secondary low voltage level that is a predetermined number of voltage steps, such as 1 voltage step, above the V_{cliff}, or just above the point at which the voltage level resulted in increased throttling. V_{edge} is the last voltage bias (V_{bias}) at which throttling was not detected. This lack of throttling resulted in lower voltage to V_{cliff} at which a large amount of throttling was detected, resulting in a voltage increase. A voltage cliff (V_{cliff}) threshold 706 comprises an amount of throttling detected during a period at the V_{cliff} voltage level. A voltage cliff (V_{cliff}) time-of-day (TOD) 708 comprises the time-of-day at which V_{cliff} occurred. The time value N 710 comprises a number of periods from the last occurrence of throttling which resulted in the increased voltage. N_{wait} 712 comprises the number of periods to wait before decreasing the V_{bias} to avoid oscillations in voltage levels. The throttling threshold 714 indicates a maximum average throttling whose occurrence results in increasing the voltage. The average throttling 716 comprises the average throttling observed since the last throttling event below the throttling threshold 714.

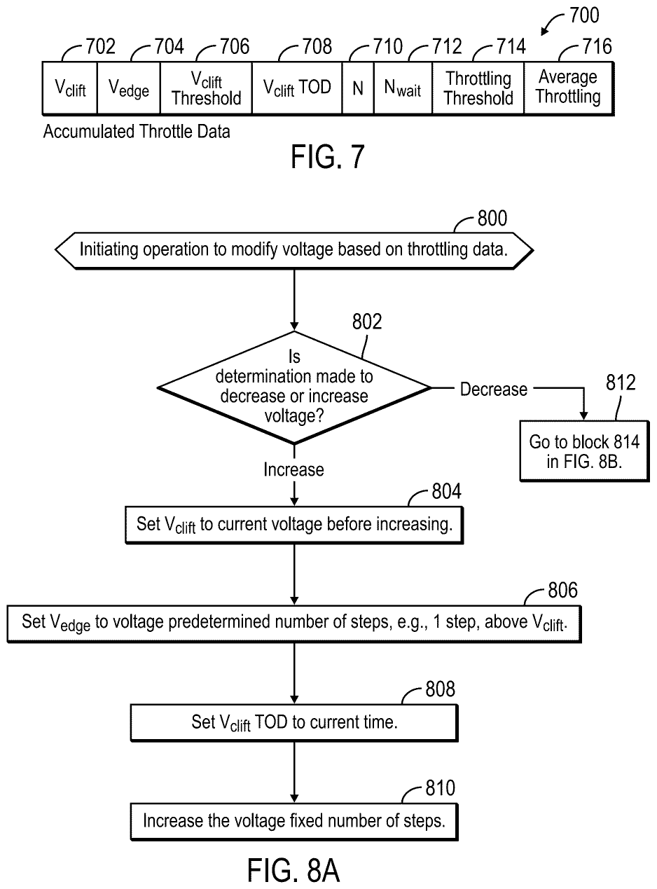

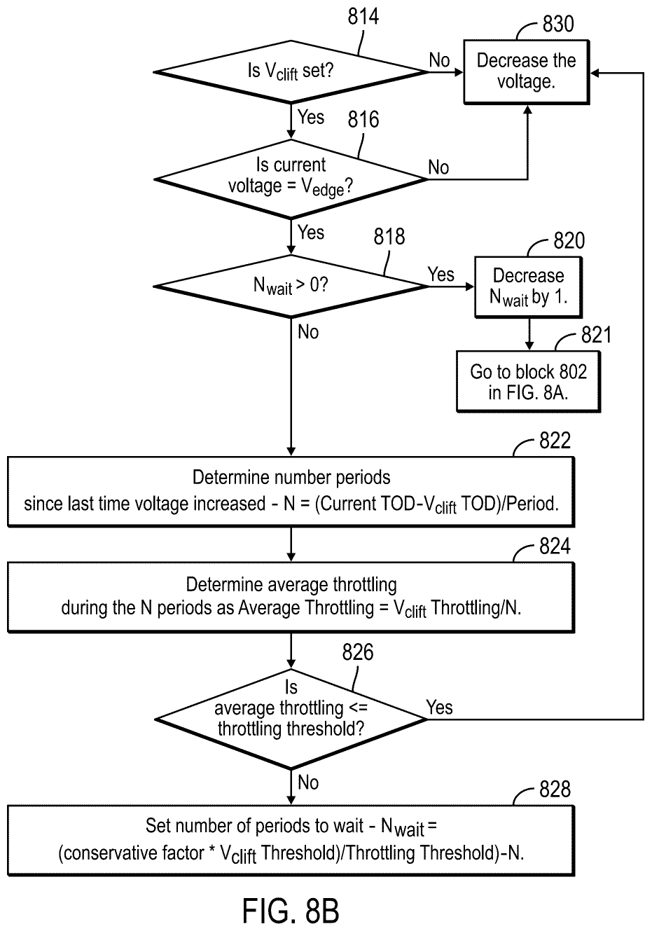

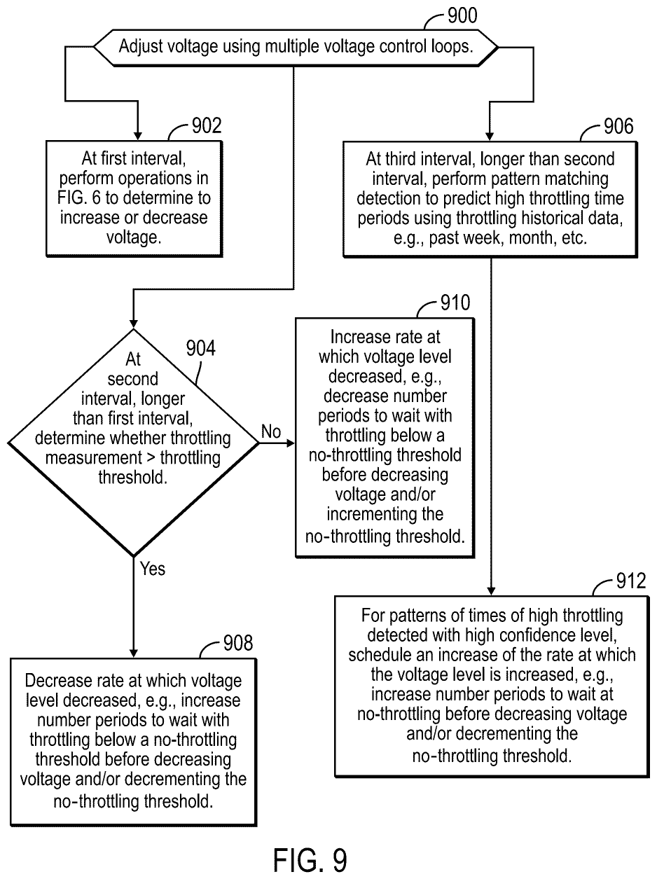

FIGS. 8A and 8B illustrate an embodiment of operations performed by the power management engine to determine when to decrease voltage. The operations of FIG. 6 may determine when to decrease voltage and the operations of FIGS. 8A and 8B determine how to handle the voltage decrease. With respect to FIG. 8A, upon initiating an operation (at block 800) to modify voltage based on throttling data, a determination is made (at block 802) whether to modify the voltage, which may be made according to the operations of FIGS. 5 and 6. Upon determining to increase the voltage, V_{cliff} is set (at block 804) to the current voltage before increasing. V_{edge} is set (at block 806) to one or more voltage steps or values above V_{cliff}. V_{cliff} TOD is set (at block 808) to a current time. The voltage is then increased (at block 810) a fixed number of steps to alleviate throttling.

If (at block 802) the determination has been made to decrease voltage as a result of no throttling for a certain number of time periods, such as in FIG. 6, control proceeds (at block 812) to block 814 in FIG. 8B. At block 814, if V_{cliff} has been set and if (at block 816) the current voltage is at V_{edge}, then a determination is made (at block 818) whether N_{wait} is greater than zero to wait for N_{wait} periods before the voltage may be decreased. If (at block 818) N_{wait} is greater than zero, then Nwait is decreased (at block 820) by one and control proceeds (at block 821) to block 802 in FIG. 8A. This avoids decreases in voltage that immediately trigger throttling resulting in oscillations of voltage level.

If (at block 818) there are no further N_{wait} periods to wait before decreasing the voltage, i.e., Nwait is zero, then the power management engine determines (at block 822) the value N, e.g., 710, as the number of periods since the last time voltage increased, or N=(Current TOD−V_{cliff} TOD)/Period. The average throttling during the N periods is determined (at block 824) as V_{cliff} throttling divided by N. If (at block 826) average throttling is greater than the throttling threshold, then the number of periods to wait before decreasing voltage (N_{wait}) is set (at block 828) to a (conservative factor*V_{cliff} Threshold)/Throttling Threshold)-N. The conservative factor comprises some value greater than 1 to protect performance. After N_{wait} is set, waiting is initiated in the following period.

If V_{cliff} is not set (from the NO branch of block 814) or if the current voltage is not at V_{edge} (from the NO branch of block 816) or if (from the YES branch of block 826) the average throttling is less than or equal to the throttling threshold, then voltage is decreased (at block 830).

With the embodiments of FIGS. 7, 8A, and 8B, voltage reductions are only made when the voltage is at a low level (V_{edge}) just above the point (V_{cliff}) where increases in voltage occur after waiting a period of time before further decreasing the voltage. The purpose is to delay voltage decreases when previous reductions at the voltage level led to high throttling. This avoids oscillations in having to increase voltage in response to reducing voltage to a low enough point where throttling returns.

FIG. 9 illustrates an embodiment of operations performed by power management engine to implement a plurality of voltage control loops to adjust voltage at different delays or intervals. The monitoring of the voltage control loops 902, 904, and 906 may begin concurrently and then operate at different intervals. At a first, shortest, interval, such as at every 256 milliseconds, the power management engine may perform (at block 902) the operations of FIGS. 6 and 8A, 8B to adjust the voltage level to avoid throttling. At a second interval, greater than the first interval, such as every minute or some other number of minutes, the power management engine determines (at block 904) whether a throttling measurement, such as the average throttling for the measured period, is greater than a throttling threshold. If so, then the power management engine decreases (at block 908) the rate at which the voltage level is decreased. This maintains a higher voltage level longer to reduce throttling which was determined excessively high. The rate at which the voltage level is decreased may be decreased by increasing the number of periods to wait with throttling below a no-throttling threshold before decreasing voltage and/or decrement the no-throttling threshold. Decrementing the no-throttling threshold requires a lower level of throttling for the number of periods to wait before decreasing the voltage. A lower no-throttling threshold makes it more difficult for the measured throttling level to satisfy the no-threshold throttling requirement. If (at block 904) the throttling measurement, e.g., average throttling, is not greater than the throttling threshold, then an increase is made (at block 910) to the rate at which the voltage level is decreased. The rate at which the voltage level is decreased may be increased by decreasing the number periods to wait with throttling below a no-throttling threshold before decreasing voltage and/or increasing the no-throttling threshold. Increasing the no-throttling threshold allows a determination of no-throttling for higher levels of throttling, to make it easier to satisfy the number of periods of no-throttling to wait before decreasing the voltage. A higher no-throttling threshold makes it more likely the voltage level will be deemed no-throttling than a lower no-throttling threshold.

In the embodiment of FIG. 6, the high performance degradation threshold may correspond to the throttling threshold described in FIG. 9 and the low performance degradation threshold may correspond to the no-throttling threshold described with respect to FIG. 9. Thus, the operations of FIG. 9 may result in decreasing the low performance degradation threshold, i.e., no-throttling threshold, to decrease the rate at which the voltage level is decreased and result in increasing the low performance degradation threshold, i.e., no-throttling threshold, to increase the rate at which the voltage level is decreased.

The third interval or longest voltage control loop may run every week, month etc., or at a longer interval than the first and second intervals. At the third interval, the power management engine performs (at block 906) pattern matching detection to predict high throttling time periods using throttling historical data, e.g., past week, month, etc. For patterns of times of high throttling detected with a high confidence level, the power management engine schedules (at block 912) an increase of the rate at which voltage level is increased. The rate at which the voltage level is increased may be increased by increasing a number of periods to wait at no-throttling before decreasing the voltage and/or decrementing the no-throttling threshold.

With the embodiment of FIG. 9, adjustments may be made to the number of steps or voltage level at which voltage is increased at different time intervals, such as at minute interval or long period interval such as a week or month, to provide further adjustment to voltage increase level based on different measurement periods. This allows for increased opportunities to adjust the voltage level increase to avoid throttling at the shorter interval detected by the DDS components.

The present invention may be a computer implemented method, system, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In the flowcharts and description, when there is a condition with different operations described as performed depending on the result of the condition, all results of the condition may occur at different times resulting in the different operations performed for the different results of the condition at different times.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

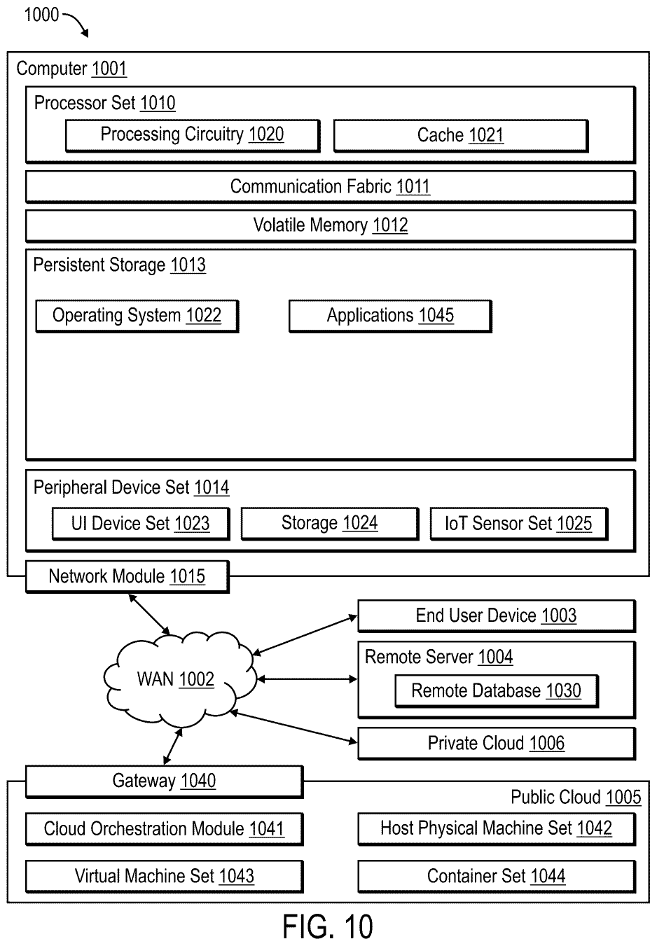

With respect to FIG. 10, computing environment 1000 contains an example of an environment for implementing of the processor components involved in performing the inventive methods, such as the interacting timing protection control loop and the voltage control loop as described above. The computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and applications 1045), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044. The processor set 1010 may comprise the system 100 described above with respect to FIGS. 1 and 2 and the processing circuitry 1020 may comprise the components of FIGS. 1 and 2 involved in the timing protection control loop and the voltage control loop of the above described embodiments.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing. The processor set 1010 may comprise the system 100 described above with respect to FIGS. 1 and 2 and the processing circuitry 1020 may comprise the components of FIGS. 1 and 2 involved in the timing protection control loop and the voltage control loop of the described embodiments.

Computer-readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1021 and the other storage media discussed below. The program instructions, and associated data, are accessed by processor set 1010 to control and direct performance of the inventive methods.

COMMUNICATION FABRIC 1011 is the signal conduction path that allows the various components of computer 1001 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer-readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

Cloud COMPUTING SERVICES AND/OR MICROSERVICES (not separately shown in FIG. 10): private and public clouds 1006 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for adjusting voltage at a processing unit, comprising:
generating, at a first sensor in a processor core, a first output value based on an operational margin at the processor core;
throttling execution at the processor core in response to the first output value satisfying a threshold condition;
generating, at a second sensor in the processor core operating at an offset margin from when the first sensor operates, a second output value based on the operational margin at the processor core;
determining a voltage change based on the second output value; and
modifying voltage supplied to the processing unit by the voltage change.

2. The computer implemented method of claim 1, further comprising:
determining a first voltage change based on the first output value; and
modifying a first voltage supplied to the processing unit by the first voltage change, wherein the voltage change based on the second output value comprises a second voltage change and wherein the voltage modified by the second voltage change comprises a second voltage.

3. The computer implemented method of claim 1, further comprising:
incrementing a first throttle count in response to output values from the first sensor satisfying the threshold condition;
incrementing a second throttle count in response to output values from the second sensor satisfying the threshold condition;
using the first throttle count to calculate a first performance degradation value;
using the first performance degradation value to determine a first voltage change, wherein the voltage change based on the second output value comprises a second voltage change;
wherein the using the second output value to determine the second voltage change comprises:
using the second throttle count to calculate a second performance degradation value; and
using the second performance degradation value to determine the second voltage change.

4. The computer implemented method of claim 1, wherein the threshold condition is satisfied in response to the first output value being less than a threshold output value, further comprising:
incrementing a threshold output value count in response to output values from the first sensor at one value greater than the threshold output value; and
using the threshold output value count to determine whether to decrease the voltage.

5. The computer implemented method of claim 1, wherein the threshold condition is satisfied in response to the first output value being less than a threshold output value, further comprising:
incrementing a threshold output value count in response to output values from the second sensor at one value greater the threshold output value; and
using the threshold output value count to determine whether to decrease the voltage.

6. The computer implemented method of claim 1, wherein the voltage change comprises a first voltage change, further comprising:
generating, at a third sensor in the processor core at an offset margin from both the first sensor and the second sensor, a third output value based on the operation margin at the processor core;
determining a second voltage change based on the third output value; and
modifying voltage supplied to the processing unit by the second voltage change.

7. The computer implemented method of claim 1, further comprising:
generating, at the second sensor, output values based on the operational margin at the processor core, wherein the determining the voltage change is based on the output values from the second sensor, including the second output value; and
throttling execution at the processor core in response to the second output value satisfying the threshold condition.

8. A computer implemented method for adjusting voltage at a processing unit, comprising:
setting a low voltage level to a first voltage level in response to determining to increase the first voltage level due to excessive throttling;
setting a secondary low voltage level greater than the low voltage level;
determining whether a second voltage level is at the secondary low voltage level in response to determining to decrease the second voltage level;
determining whether a throttling measurement is below a throttling threshold in response to determining that the voltage level is at the secondary low voltage level; and
decreasing the second voltage level in response to determining that the throttling measurement is below the throttling threshold.

9. The computer implemented method of claim 8, wherein the throttling measurement comprises average throttling since increasing the voltage.

10. The computer implemented method of claim 9, wherein the average throttling is calculated as an amount of throttling since increasing the first voltage level divided by a number of periods since increasing the first voltage level.

11. The computer implemented method of claim 8, wherein the throttling measurement comprises a first throttling measurement, further comprising:
waiting a number of periods in response to determining that the first throttling measurement is above the throttling threshold before decreasing the second voltage level;
in response to waiting the number of periods, determining whether a second throttling measurement is below the throttling threshold; and
decreasing the second voltage level in response to determining that the second throttling measurement is below the throttling threshold.

12. The computer implemented method of claim 11, wherein the number of periods to wait is based on an amount of throttling since increasing the first voltage level and wherein the number of periods to wait increases as the amount of throttling since increasing the first voltage level.

13. The computer implemented method of claim 11, wherein the number of periods to wait comprises a factor, greater than one, times an amount of throttling since increasing the first voltage level divided by the throttling threshold minus a number of periods since the first voltage level was increased.

14. The computer implemented method of claim 8, further comprising:
determining whether the low voltage level is set in response to determining to decrease the second voltage level; and
decreasing the second voltage level in response to determining that the low voltage level is not set.

15. A computer implemented method for adjusting voltage at a processing unit, comprising:
a first voltage control loop running at a first interval to determine whether a first interval throttling measurement, based on a number of times execution at a processor core was throttled during the first interval, exceeds a first throttling threshold;
increasing a voltage level a number of steps in response to determining that the first interval throttling measurement exceeds a throttling threshold;
a second voltage control loop running at a second interval, longer than the first interval, to determine whether a second interval throttling measurement, based on a number of times the processor core was throttled during the second interval, exceeds the throttling threshold; and
changing a rate at which the voltage level is decreased in response to determining that the second interval throttling measurement exceeds the throttling threshold.

16. The computer implemented method of claim 15, wherein the throttling threshold comprises a first throttling threshold, wherein the changing the rate at which the voltage level is adjusted in response to determining that the second interval throttling measurement exceeds the first throttling threshold comprises performing at least one of:
increasing the number of periods required during which throttling is below a second throttling threshold before decreasing the voltage level, wherein the second throttling threshold is less than the first throttling threshold; and
decrementing the first throttling threshold.

17. The computer implemented method of claim 15, wherein the throttling threshold comprises a first throttling threshold, wherein the changing the rate at which the voltage level is adjusted in response to determining that the second interval throttling measurement is below the first throttling threshold comprises performing at least one of:
decreasing the number of periods required during which throttling is below a second throttling threshold before decreasing the voltage level, wherein the second throttling threshold is less than the first throttling threshold; and
incrementing the second throttling threshold.

18. The computer implemented method of claim 15, further comprising:
a third voltage control loop running at a third interval, longer than the second interval, to determine whether a third interval throttling measurement, based on a number of times the processor core was throttled during the third interval, exceeds the throttling threshold;
performing pattern matching detecting to predict high throttling time periods using historical throttling data; and
scheduling, for the high throttling time periods, to decrease the rate at which the voltage level is decreased to maintain the voltage level at a higher level.

19. A processor, comprising:
a core including:
a first sensor to generate a first output value based on an operational margin at the core;
a second sensor, in the core operating at an offset margin from when the first sensor operates, generates a second output value based on the operational margin at the core; and
a mitigation unit to throttle execution at the core in response to the first output value satisfying a threshold condition; and
a power management engine implemented in the processor to perform:
determining a voltage change based on the second output value; and
modifying voltage supplied to the core by the voltage change.

20. The processor of claim 19, wherein the power management engine further performs:
determining a first voltage change based on the first output value; and
modifying a first voltage supplied to the core by the first voltage change, wherein the voltage change based on the second output value comprises a second voltage change and wherein the voltage modified by the second voltage change comprises a second voltage.

21. The processor of claim 19, wherein the power management engine further performs:
incrementing a first throttle count in response to output values from the first sensor satisfying the threshold condition;
incrementing a second throttle count in response to output values from the second sensor satisfying the threshold condition;
using the first throttle count to calculate a first performance degradation value;
using the first performance degradation value to determine a first voltage change, wherein the voltage change based on the second output value comprises a second voltage change;
wherein the using the second output value to determine the second voltage change comprises:
using the second throttle count to calculate a second performance degradation value; and
using the second performance degradation value to determine the second voltage change.

22. The processor of claim 19, wherein the threshold condition is satisfied in response to the first output value being less than a threshold output value, wherein the power management engine further performs:
incrementing a threshold output value count in response to output values from the first sensor at one value greater than the threshold output value; and
using the threshold output value count to determine whether to decrease the voltage.

23. A processor, comprising:
a core; and
a power management engine to perform operations, the operations comprising:
setting a low voltage level to a first voltage level in response to determining to increase the first voltage level due to excessive throttling;
setting a secondary low voltage level greater than the low voltage level;
determining whether a second voltage level is at the secondary low voltage level in response to determining to decrease the second voltage level;
determining whether a throttling measurement is below a throttling threshold in response to determining that the second voltage level is at the secondary low voltage level; and
decreasing the second voltage level supplied to the core in response to determining that the throttling measurement is below the throttling threshold.

24. The processor of claim 23, wherein the throttling measurement comprises a first throttling measurement, wherein the operations performed by the power management engine further comprise:
waiting a number of periods in response to determining that the first throttling measurement is above the throttling threshold before decreasing the second voltage level;
in response to waiting the number of periods, determining whether a second throttling measurement is below the throttling threshold; and
decreasing the second voltage level supplied to the core in response to determining that the second throttling measurement is below the throttling threshold.

25. The processor of claim 23, wherein the operations performed by the power management engine further comprise:
determining whether the low voltage level is set in response to determining to decrease the second voltage level; and
decreasing the second voltage level supplied to the core in response to determining that the low voltage level is not set.
